(19) United States
(12) Patent Application Publication
(10) Pub. No.: US 2012/0064312 A1
(43) Pub. Date: Mar. 15, 2012

(54) USE OF RADIATION-CURABLE COATING MATERIAL FOR COATING WOOD-BASE MATERIALS

(75) Inventors: Matthias Lokai, Enkenbach-Alsenborn (DE); Oscar Lafuente Cerda, Ebersberg (DE); Axel Becker, Altrip (DE)

(73) Assignee: BASF SE, LUDWIGSHAFEN (DE)

(21) Appl. No.: 13/321,263

(22) PCT Filed: Jun. 1, 2010
(86) PCT No.: PCT/EP10/57612

§ 371 Date: Nov. 18, 2011

(30) Foreign Application Priority Data
Jun. 10, 2009 (EP) 09162351.2

(51) Int. Cl. B32B 21/08; C08F 2/46; B32B 3/18; C08F 2/48

(52) U.S. Cl. 428/201; 428/514; 427/492; 427/493

(57) ABSTRACT

The present invention relates to the use of radiation-curable coating material for coating wood-base materials, a method for coating wood-base materials and the coated wood-base materials thus obtained.

The present invention relates to the use of a radiation-curable coating material for coating wood-base materials, a method for coating wood-base materials and the coated wood-base materials thus obtained.

Radiation-curable coating materials are widely used for coating all possible substrates, such as plastics, metals and wood-base materials.

Particularly in the coating of wood-base materials which can be used as floor coverings, for example parquet or laminate, the abrasion resistance has to meet high requirements. With the use of commercially available radiation-curable coating materials, however, hard and at the same time brittle coatings are frequently obtained.

There was therefore the need for a radiation-curable coating material for wood-base materials which give abrasion-resistant and hard coatings which have elasticity.

The object was achieved by the use of radiation-curable coating materials, comprising

(A) at least one unsaturated polyester resin,

(B) at least one at least difunctional (meth)acrylate and

(C) at least one inorganic material,

with the proviso that the double bond density of the radiation-curable coating material, based on the components (A) and (B), is at least 4 mol of double bonds per kg, for coating wood-base materials.

The coating materials according to the claims lead, after curing, to abrasion-resistant coatings which are outstandingly suitable in particular for floor coverings.

The component (A) is at least one unsaturated polyester resin, for example one to four, preferably one to three, particularly preferably one or two, unsaturated polyester resins and very particularly preferably exactly one unsaturated polyester resin, as known per se to the person skilled in the art.

It is preferably an unsaturated polyester resin which is at least composed of the components

(a1) maleic acid or derivatives thereof,

(a2) at least one cyclic dicarboxylic acid or derivatives thereof,

(a3) at least one aliphatic or cycloaliphatic diol.

In the context of this document, derivatives are preferably understood as meaning

the relevant anhydrides in monomeric or polymeric form,

mono- or dialkyl esters, preferably mono- or di-C₁-C₄-alkyl esters, particularly preferably mono- or dimethyl esters or the corresponding mono- or diethyl esters,

furthermore mono- and divinyl esters and

mixed esters, preferably mixed esters having different C₁-C₄-alkyl components, particularly preferably mixed methyl ethyl esters.

In the context of this document, C₁-C₄-alkyl means methyl, ethyl, isopropyl, n-propyl, n-butyl, isobutyl, sec-butyl and tert-butyl, preferably methyl, ethyl and n-butyl, particularly preferably methyl and ethyl and very particularly preferably methyl.

In the context of the present invention, it is also possible to use a mixture of a dicarboxylic acid and one or more of its derivatives. In the context of the present invention, it is also possible to use a mixture of a plurality of different derivatives of one or more dicarboxylic acids.

The component (a1) is maleic acid or derivatives thereof, preferably maleic acid or maleic anhydride.

The component (a2) is at least one cyclic dicarboxylic acid, preferably one to four, particularly preferably one to three, cyclic dicarboxylic acids and very particularly preferably exactly one cyclic dicarboxylic acid or derivatives thereof.

In the context of the present document, a cyclic compound is understood as meaning a compound which at least comprises one carbo- or heterocycle, preferably one or two carbo- or heterocycles and particularly preferably exactly one carbo- or heterocycle, preferably carbocycle. These may be aromatic or alicyclic compounds, the latter comprising both compounds partly unsaturated in the ring and saturated compounds.

The cycles are preferably five- or six-membered cycles, particularly preferably six-membered cycles.

Examples of aromatic components (a2) are phthalic acid, isophthalic acid or terephthalic acid; (a2) is preferably selected from the group consisting of phthalic acid and terephthalic acid.

Examples of alicyclic components (a2) are cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid and cyclohex-1-ene-1,2-dicarboxylic acid. They are preferably industrial isomer mixtures of hexahydro- and tetrahydrophthalic acid.

The component (a3) is at least one aliphatic or cycloaliphatic diol, preferably one to four, particularly preferably one to three, very particularly preferably one or two, aliphatic or cycloaliphatic diols and in particular exactly one aliphatic or cycloaliphatic diol.

For example, ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- and 1,3-cyclopentanediols, 1,2-, 1,3- and 1,4-cyclohexanediols, 1,1-, 1,2-, 1,3- and 1,4-bis(hydroxymethyl)cyclohexanes, 1,1-, 1,2-, 1,3- and 1,4-bis(hydroxyethyl)cyclohexanes, neopentylglycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, n being an integer and n≧4, polyethylene polypropylene glycols, it being possible for the sequence of the ethylene oxide and of the propylene oxide units to be blockwise or random, polytetramethylene glycols, preferably up to a molecular weight of up to 5000 g/mol, poly-1,3-propanediols, preferably having a molecular weight of up to 5000 g/mol, polycaprolactones or mixtures of two or more representatives of the above compounds.

Preferably used diols are ethylene glycol, 1,2-propanediol, 1,3-propanediol, 1,4-butanediol, 1,5-pentanediol, 1,6-hexanediol, 1,8-octanediol, 1,2-, 1,3- and 1,4-cyclohexanediol, 1,3- and 1,4-bis(hydroxymethyl)cyclohexane, and diethylene glycol, triethylene glycol, dipropylene glycol and tripropylene glycol.

The diols may optionally comprise further functionalities, such as, for example, carbonyl, carboxyl, alkoxycarbonyl or sulfonyl, such as, for example, dimethylolpropionic acid or dimethylolbutyric acid, and the C₁-C₄-alkyl esters thereof, but the diols preferably have no further functionalities.

Particularly preferred aliphatic diols are those which have 2 to 6 carbon atoms. The aliphatic diols selected from the group consisting of diethylene glycol and neopentylglycol are very particularly preferred.

The diol (a2) can also preferably be cycloaliphatic diols, particularly preferably 1,1-, 1,2-, 1,3- and 1,4-bis(hydroxymethyl)cyclohexanes or 2,2-bis(4-hydroxycyclohexyl)propane.

In addition to the synthesis components (a1), (a2) and (a3), the unsaturated polyester resin (A) may optionally also comprise further components:

At least one dicarboxylic acid or derivatives thereof other than (a1) and (a2) may optionally be present as synthesis component (a4). The component (a4) may be, for example, other acyclic dicarboxylic acids, preferably oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid or fumaric acid, particularly preferably malonic acid, succinic acid, glutaric acid and adipic acid.

(a5) Furthermore, at least one polycarboxylic acid having a functionality of 3 or more or derivatives thereof may optionally be present.

Examples of these are aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid) and mellitic acid and low molecular weight polyacrylic acids.

Furthermore, a diol other than those described under (a3) may be present as further optional synthesis component (a6).

Furthermore, a polyol having a functionality of 3 or more may be present as further optional synthesis component (a7).

Examples of these are glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol or higher condensates of glycerol, di(trimethylolpropane), di(pentaerythritol), trishydroxymethyl isocyanurate, tris(hydroxyethyl) isocyanurate (THEIC), tris(hydroxypropyl) isocyanurate, inositols or sugars, such as, for example, glucose, fructose or sucrose, sugar alcohols, such as, for example, sorbitol, mannitol, threitol, erythritol, adonitol (ribitol), arabitol (lyxitol), xylitol, dulcitol (galactitol), maltitol, isomalt, trifunctional or higher-functional polyetherols based on trifunctional or higher-functional alcohols and ethylene oxide, propylene oxide and/or butylene oxide.

The composition of the unsaturated polyester resins (A) is as a rule as follows:

(a1) 30-70 mol %, based on all carboxyl groups present in (A) and derivatives thereof, preferably 40-60 mol %,

(a2) 30-70 mol %, based on all carboxyl groups present in (A) and derivatives thereof, preferably 40-60 mol %,

(a3) 80-100 mol %, based on all hydroxyl groups present in (A), preferably 100 mol %,

(a4) 0-20 mol %, based on all carboxyl groups present in (A) and derivatives thereof, preferably 0 mol %,

(a5) 0-5 mol %, based on all carboxyl groups present in (A) and derivatives thereof, preferably 0 mol %,

(a6) 0-20 mol % based on all hydroxyl groups present in (A), preferably 0 mol %, and

(a7) 0-5 mol % based on all hydroxyl groups present in (A), preferably 0 mol %,

with the proviso that the sum of all hydroxyl groups is 100 mol % and the sum of all carboxyl groups is 100 mol %, and the stoichiometry of hydroxyl groups to carboxyl groups is from 1:0.85 to 1:1.25, preferably from 1:0.9 to 1:1.2 and particularly preferably from 1:0.95 to 1:1.15.

Preferred unsaturated polyester resins (A) have a glass transition temperature Tg, measured by the DSC method (Differential Scanning Calorimetry) according to ASTM 3418/82 at a heating rate of 20° C./min, of 0° C. or more, preferably 10° C. or more and particularly preferably 25° C. or more.

Preferred unsaturated polyester resins (A) have a number average molecular weight Mₙ of from 1000 to 10 000 g/mol (determined by gel permeation chromatography with polystyrene as standard, tetrahydrofuran solvent), preferably from 1500 to 8000 and particularly preferably from 2000 to 5000 g/mol.

The component (B) is at least one at least difunctional (meth)acrylate, preferably one to four, particularly preferably one to three, very particularly preferably one or two, at least difunctional (meth)acrylates and in particular exactly one at least difunctional (meth)acrylate.

The functionality of the (meth)acrylate is preferably from 2 to 6, particularly preferably from 3 to 6 and very particularly preferably from 3 to 4.

The (meth)acrylates are esters of acrylic acid and/or methacrylic acid, preferably acrylic acid, with polyols of the abovementioned functionality.

The polyols are optionally alkoxylated (cyclo)alkanepolyols, ethylene oxide and/or propylene oxide preferably being used for the alkoxylation. In a preferred embodiment, the (cyclo)alkanepolyols are not alkoxylated.

The (cyclo)alkanepolyols may be, for example, alcohols having 2 to 12 carbon atoms. Ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentylglycol, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt are preferred.

Among these, the alkanepolyols are preferred, particularly preferably alkanediols, alkanetriols and alkanetetraols, very particularly preferably alkanetriols and alkanetetraols.

In particular, the polyols are 1,6-hexanediol, dipropylene glycol, tripropylene glycol, glycerol, trimethylolpropane or pentaerythritol; accordingly, the acrylates thereof are particularly preferred as compounds (B).

The compounds (A) and (B) are preferably mixed with one another in the weight ratio of from 3:1 to 1:3, preferably 2:1 to 1:2, particularly preferably from 1.5:1 to 1:1.5 and very particularly preferably from 1.2:1 to 1:1.2.

It is an advantage if the mixture of the compounds (A) and (B) with one another has a melting point below 0° C., preferably below −10° C., particularly preferably below −20° C. and very particularly preferably below −30° C.

It is a feature according to the invention for achieving the desired high abrasion resistance that the double bond density of the radiation-curable coating material, based on the components (A) and (B), is at least 4 mol of double bonds per kg, preferably at least 4.5, particularly preferably at least 5, very particularly preferably at least 5.5 and in particular at least 6.0 mol of double bonds per kg. The activated double bonds available for the radiation curing are counted as double bonds, preferably α,β-ethylenically unsaturated carbonyl groups and in particular the sum of the maleic acid groups, acrylate and methacrylate groups in the components (A) and (B).

The component (C) is an inorganic material for further improving the abrasion resistance, which preferably has a particle size of from 50 nm to 400 μm, preferably from 80 nm to 300 μm, particularly preferably from 100 nm to 200 μm, very particularly preferably from 200 nm to 100 μm and in particular from 500 nm to 50 μm.

The component (C) is preferably selected from the group consisting of diamond, garnet, pumice, tripoli, silicon carbide, emery, corundum, alumina, kieselguhr, sand (abrasive sand), gypsum, boron carbide, borides, carbides, nitrides and cerium oxide. Corundum, alumina, silicon carbide and kieselguhr are particularly preferred and corundum and alumina are very particularly preferred, in particular alumina.

The proportion of the component (C), based on the total amount of the compounds (A), (B) and (C), is as a rule from 5 to 40% by weight, preferably from 8 to 35 and particularly preferably from 10 to 30% by weight.

The radiation-curable coating materials according to the invention may comprise further components, for example additives and photoinitiators customary for coatings.

If the curing of the coating materials is not effected with electron beams but by means of UV radiation, preferably at least one photoinitiator which can initiate the polymerization of ethylenically unsaturated double bonds is present.

Photoinitiators may be, for example, photoinitiators known to the person skilled in the art, for example those mentioned in “Advances in Polymer Science”, Volume 14, Springer Berlin 1974, or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds), SITA Technology Ltd, London.

For example, mono- or bisacylphosphine oxides, as described, for example, in EP-A 7 508, EP-A 57 474, DE-A 196 18 720, EP-A 495 751 or EP-A 615 980, are suitable, for example 2,4,6-trimethylbenzoyldiphenylphosphine oxide (Lucirin® TPO from BASF SE), ethyl 2,4,6-trimethylbenzoylphenylphosphinate (Lucirin® TPO L from BASF SE), bis(2,4,6-trimethylbenzoyl)phenylphosphine oxide (Irgacure® 819 from Ciba Spezialitätenchemie), benzophenones, hydroxyacetophenones, phenylglyoxylic acid and its derivatives or mixtures of these photoinitiators. Benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylates, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-di-isopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7-H-benzoin methyl ether, benz[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzyl ketals, such as benzyl dimethyl ketal, 2-methyl-1-[4-(methylthio)phenyl]-2-morpholinopropan-1-one, anthraquinones, such as 2-methylanthraquinone, 2-ethylanthraquinone, 2-tert-butylanthraquinone, 1-chloroanthraquinone, 2-amylanthraquinone and 2,3-butandione are mentioned as examples.

Photoinitiators of the phenylglyoxylic acid ester type which do not yellow or yellow slightly, as described in DE-A 198 26 712, DE-A 199 13 353 or WO 98/33761, are also suitable.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenyl-propan-1-one, 2,4,6-trimethylbenzophenone and 4-methylbenzophenone or 2,4,6-trimethylbenzophenone and 4-methylbenzophenone and 2,4,6-trimethylbenzoyldiphenylphosphine oxide.

Preferred among these photoinitiators are 2,4,6-trimethylbenzoyldiphenylphosphine oxide, ethyl-2,4,6-trimethylbenzoylphenylphosphinate, bis(2,4,6-tri-methylbenzoyl)phenylphosphine oxide, benzophenone, 1-benzoylcyclohexan-1-ol, 2-hydroxy-2,2-dimethylacetophenone and 2,2-dimethoxy-2-phenylacetophenone.

The coating materials comprise the photoinitiators preferably in an amount of from 0.05 to 10% by weight, particularly preferably from 0.1 to 8% by weight, in particular from 0.2 to 5% by weight, based on the total amount of the components (A) to (C).

The coating materials may comprise further additives customary in coatings, such as leveling agents, antifoams, UV absorbers, dyes, pigments and/or fillers.

Suitable fillers comprise silicates, for example silicates obtainable by hydrolysis of silicon tetrachloride, such as Aerosil® R from Degussa, siliceous earth, talc, aluminum silicates, magnesium silicates, calcium carbonates, etc. Suitable stabilizers comprise typical UV absorbers, such as oxanilides, triazines and benzotriazole (the latter is obtainable as Tinuvin® R grades from Ciba-Spezialitätenchemie) and benzophenones.

These may be used alone or together with suitable free radical scavengers, for example sterically hindered amines, such as 2,2,6,6-tetramethylpiperidine, 2,6-di-tert-butylpiperidine or derivatives thereof, e.g. bis(2,2,6,6-tetramethyl-4-piperidyl) sebacate. Stabilizers are usually used in amounts of from 0.1 to 5.0% by weight, based on the “solid” components present in the formulation.

It is an advantage of the coating materials according to the invention that they have a high abrasion resistance and scratch resistance and preferably have at least one of the following advantages:

little turbidity,

little yellowing,

good adhesion to wood and wood-base materials.

The coating materials are suitable in particular for coating wood, wood-base materials and wood-containing substrates, such as fiber boards. The coating of cellulose fibers, such as, for example, paper, board or cardboard, would also be conceivable.

In the context of the present document, the term “wood-base materials” is used as a general term for various products which form as a result of separation of the wood and subsequent combination, generally with addition of other substances, such as, for example, adhesives or resins or mineral binder. These include, for example, solid wood boards (DIN EN 12775: April 2001), plywood (DIN EN 313-2: November 1999), particle boards (DIN EN 300: June 1997, DIN EN 309: August 1992, DIN EN 633: December 1993), laminates (DIN EN 438-1: June 2002) and fiber boards (DIN EN 316: December 1999) and laminated wood obtained by gluing veneers.

Solid wood boards are boards composed of wood pieces adhesively bonded in one layer or a plurality of layers.

Plywood is a composite of layers adhesively bonded to one another, the fiber directions of successive layers being arranged at right angles to one another and thereby mutually blocking one another.

Particle boards are produced by pressing small pieces of wood with synthetic resins, natural substances or—although less preferred—mineral materials, such as cement (wood cement boards) and gypsum. A distinction is therefore made between particle boards having an orientation of the particles (OSB=oriented structural board), particle boards having little or no orientation of the particles (e.g. flat-pressed particle boards) and cement-bound particle boards. They are more isotropic than solid wood and have better durability and, depending on the density, greater homogeneity of the surface. They are grouped according to types of use and classified according to the content of free formaldehyde. Particle boards generally serve as supports for further coatings, for example film coatings.

Laminates (decorative high-pressure laminates) consist of paper webs which are impregnated, for example, with melamine resins and/or phenol resins (melamine laminates) and pressed at elevated temperatures. Depending on the method of pressing, they are designated according to DIN EN 438-1: December 1992 as HPL (high-pressure laminates) or CPL (continuous pressure laminates) and are preferably used on pieces of furniture subject to high stress, e.g. worktops in the kitchen.

Fiber boards are produced from ligneous fibers without binder by the wet process or with binder by the dry process as single-layer or multilayer boards. They are likewise substantially isotropic in the plane of the board. Their properties depend on the degree of grinding of the fiber, the production conditions (pressing temperature, duration of pressing and course of pressing), the method of gluing and amount of glue, on the density and its distribution over the board cross section, the material moisture content and the aftertreatment. A distinction is made between porous, hard and medium-hard fiber boards for the building industry, medium-hard fiber boards for furniture, bitumen fiber boards and decorative plastic-coated fiber boards. The medium-hard boards are colloquially designated as medium-density fiber boards (MDF). They have thicknesses of, as a rule, 3-60 mm and densities of 350-850 kg/m³. High-density fiber boards (HDF) have even higher densities. Owing to their very homogeneous structure, they can also be directly laminated with profiled narrow surfaces and coated.

Fiber boards and solid woods may be mentioned as preferred wood-base materials.

Preferred woods are in particular those which are usually used for parquet, for example oak, spruce, pine, beech, maple, chestnut, plane, false acacia, ash, birch, stone pine and elm, and cork.

In a preferred embodiment, the coating materials according to the invention are used for coating parquets and laminates, and there in particular as a constituent of the surface layer.

Parquets are composed in such a way that a series of coatings are applied to the wood layer, as a rule at least one protective layer to prevent soiling and UV damage, at least one filler coat, at least one sealing coat and a surface layer. Of these coating layers, at least the surface layer is radiation-curable; in general, a plurality of the coating layers are radiation-curable, preferably all coating layers above the protective layer to prevent soiling and UV damage.

Laminates are generally composed in such a way that a fiber board, preferably a high-density fiber board, a primer and a base coat are applied, which are preferably water-based. Either a support with a desired decoration, as a rule a paper printed with a wood grain, is applied thereon or the desired decoration is printed on directly, i.e. without the support mentioned. The printing ink may be solvent-based or water-based.

The decorative layer is fixed and sealed and is provided with at least one surface layer. The radiation-curable coating material according to the invention is at least part of the surface layer; it may be expedient to cover the radiation-curable coating material according to the invention also with other surface layers.

Of these coating layers, at least the surface layer is radiation-curable, in general a plurality of the coating layers are radiation-curable, preferably primer, sealing layer and surface layer, preferably all coating layers.

The back of the laminates can be treated with a resin layer, for example a melamine resin, in order to increase the moisture resistance of the laminate.

The coating of the substrates is effected by customary methods known to the person skilled in the art, at least one coating material being applied in the desired thickness to the substrate to be coated and the volatile constituents of the coating materials being removed. This process can, if desired, be repeated once or several times. The application to the substrate can be effected in a known manner, for example by spraying, application with a trowel, knife-coating, brushing on, application with rollers having a hard or soft covering or pouring.

The thickness of the coating is as a rule in a range from about 3 to 1000 g/m² and preferably from 10 to 200 g/m².

If a plurality of layers of the coating material are applied one on top of the other, radiation-curing can be effected, if appropriate, after each coating process.

The radiation curing is effected by the action of high-energy radiation, i.e. UV radiation or daylight, preferably light of the wavelength from 250 to 600 nm, or by a radiation with high-energy electrons (electron beams; from 150 to 300 keV). Radiation sources used are, for example, high-pressure mercury vapor lamps, lasers, pulsed lamps (flashlight), halogen lamps or excimer radiators. The radiation dose usually sufficient for crosslinking in the case of UV curing is in the range from 80 to 3000 mJ/cm².

The irradiation can, if appropriate, also be carried out in the absence of oxygen, for example under an inert gas atmosphere. Suitable inert gases are preferably nitrogen, noble gases, carbon dioxide or combustion gases. Furthermore, irradiation can be effected by covering the coating material with transparent media. Transparent media are, for example, plastic films, glass or liquids, e.g. water. Irradiation in the manner described in DE-A1 199 57 900 is particularly preferred.

In a preferred method, the curing is effected continuously by conveying the substrate treated with the coating material at a constant speed past a radiation source. For this purpose, the curing speed of the coating material has to be sufficiently high.

In general, the method for coating wood-base materials with at least two different radiation-curable coating materials, at least one of which is a radiation-curable coating material according to the invention and at least one of which is another radiation-curable coating material according to the invention, may comprise the following steps:

coating of a face of the wood-base material with a primer, if appropriate followed by drying of the coating,

printing on the coating thus obtained with at least one printing ink, if appropriate followed by drying of the print,

coating of the print layer with at least one radiation-curable coating material according to the invention, if appropriate followed by at least partial curing of the coating material thus applied, by means of UV radiation or electron beams,

coating with at least one further radiation-curable coating material, which is a coating material other than that in the prior step,

followed by substantially complete curing by means of UV radiation or electron beams.

If required, the surfaces may be slightly roughened between the individual steps in order to produce improved adhesion of the next layer.

The present invention also relates to the coated wood-base material obtained thereby, and said wood-base material is composed of the following layers (from top to bottom)

optionally radiation-curable top layer,

radiation-curable coating material according to the invention,

print layer,

primer,

wood-base material,

optional seal on the back.

The coating of wood-base materials is described by way of example below:

The wood-base material, for example a medium-density fiber board, is coated with 10-15 g/m² of a water-based styrene-acrylate dispersion after sanding for surface cleaning and is then dried in a drying tunnel. After roughening of the surface, 20 g/m² of a pigmented and water-based filler are applied and once again drying is effected in the drying tunnel. About 20 g/m² of an aqueous pigmented primer are applied to this surface which has been roughened again and drying is effected.

After application of a further 20 g/m² of an aqueous primer and 20 g/m² of an aqueous seal on the back of the wood-base material and a drying step, the surface thus obtained is provided with the desired motif with three-color printing indirectly by gravure printing with 6 g/m² of printing ink.

From 75 to 100 g/m² of a radiation-curable coating material according to the invention to which corundum has been added as component (C) are applied to the print, partial curing is effected with UV light, from 15 to 25 g/m² of radiation-curable clear coat for sealing are applied thereon and curing is effected with UV light. After roughening, about 8 to 15 g/m² of a top coat are applied to this surface, partial curing is effected with UV light, overcoating is effected with from 5 to 10 g/m² of the same clear coat and complete hardening is effected with UV light.

Testing of the abrasion resistance (Tabe Abraser S 42):

In all experiments, an aqueous adhesive primer was first applied to beech parquet. The abrasion-resistant primer according to the table was applied in two layers of about 40 g/m². 10 g/m² of a matt formulation based on an epoxide acrylate were applied as a top coat. All layers were applied with the roll, and the coat weight per layer was weighed and was determined in g/m². All layers were only partly gelled and only the topcoat was completely cured. No sanding was effected between the individual layers. The number of revolutions of the Taber Abraser until the substrate was rubbed through was determined. The abrasive paper was changed every 200 revolutions. The abrasion resistance is stated as the number of revolutions/g of coat. Any variations in the layer thickness are compensated thereby and the results can be readily compared.

Results for S 42:

| Product (20% by weight of corundum added | Revolutions/ |
|---|---|
| in each case) | g of coat |
| Polyester acrylate (comparison, acrylated | 10.2 |
| polyester based on phthalic anhydride, adipic | |
| acid, trimethylolpropane, ethylene glycol, Mn | |
| about 1000) | |
| Aromatic epoxide acrylate (comparison, | 13.3 |
| bisphenol A diglycidyl ether diacrylate, | |
| dissolved in ethoxylated trimethylolpropane | |
| triacrylate) | |
| Amine-modified aromatic epoxide acrylate | 10.6 |
| (comparison, amine-modified bisphenol A | |
| diglycidyl ether diacrylate, dissolved in | |
| ethoxylated trimethylolpropane triacrylate) | |
| Unsaturated polyester resin (tetrahydrophthalic | 29.6 |
| anhydride, maleic anhydride, diethylene glycol, | |
| Mn about 2600 g/mol), dissolved in | |
| trimethylolpropane triacrylate (according to | |
| the invention) | |
| Flexible urethane acrylate (comparison, | 4.7 |
| polyurethane based on toluene diisocyanate | |
| (isomer mixture), polyethylene glycol, | |
| 2-hydroxyethyl acrylate, 65% strength solution | |
| in dipropylene glycol diacrylate) | |

It is evident that the usnsaturated polyester resin according to the invention with trifunctional acrylate, to which a resin corundum has been added as component (C), gives results which are 2-3 times better than the standard products customary in the market.

1. A process for coating a wood-based material with a radiation-curable coating material, the process comprising:
contacting the radiation-curable material with a surface of the wood-base material,
wherein the radiation-curable coating comprises
(A) at least one unsaturated polyester resin,
(B) at least one at least difunctional (meth)acrylate, and
(C) at least one inorganic material,
with the proviso that a double bond density of the radiation-curable coating material, based on (A) and (B), is at least 4 mol of double bonds per kg.

2. The process of claim 1, wherein the unsaturated polyester resin (A) comprises, as formal synthesis components,
(a1) maleic acid or a maleic acid derivative,
(a2) at least one cyclic dicarboxylic acid or a cyclic dicarboxylic acid derivative, and
(a3) at least one aliphatic or cycloaliphatic diol.

3. The process of claim 2, wherein (a2) is at least one selected from the group consisting of phthalic acid, terephthalic acid, tetrahydrophthalic acid, hexahydrophthalic acid a phthalic acid derivative, a terephthalic acid derivative, a tetrahydrophthalic acid derivative, and a hexahydrophthalic acid derivative.

4. The process of claim 2, wherein (a3) is an aliphatic diol comprising 2 to 6 carbon atoms.

5. The process of claim 2, wherein (a3) is at least one selected from the group consisting of diethylene glycol and neopentylglycol.

6. The process of claim 1, wherein (B) is a (meth)acrylate of an alkanepolyol.

7. The process of claim 6, wherein (B) comprises from 3 to 6 (meth)acrylate functions.

8. The process of claim 1, wherein (C) is at least one selected from the group consisting of diamond, garnet, pumice, tripoli, silicon carbide, emery, corundum, alumina, kieselguhr, sand (abrasive sand), gypsum, boron carbide, a boride, a carbide, a nitride, and cerium oxide.

9. The process of claim 1, wherein the wood-base material is at least one selected from the group consisting of a MDF board, an HDF board, a solid wood board, a layer-glued wood layer, and a face-glued wood layer.

10. A method for coating a wood-base material with at least two different radiation-curable coating materials, the method comprising:
(a) coating of a face of the wood-base material with a primer, to obtain a primer coating;
(b) printing on the primer coating with at least one printing ink, to obtain a print layer;
(c) coating the print layer with at least one radiation-curable coating material of claim 1, to obtain a first radiation curable coating;
(d) coating the first radiation curable coating with at least one further radiation-curable coating material which is a different coating material than in (c); and then
(e) substantially complete curing with UV radiation or an electron beam.

11. A coated wood-based material, comprising:
at least one layer comprising the radiation-curable coating of claim 1,
a print layer;
a primer layer; and
a wood-base material layer.

12. The process of claim 1, wherein (B) is a (meth)acrylate of an alkoxylated alkanepolyol.

13. The process of claim 12, wherein (B) comprises from 3 to 6 (meth)acrylate functions.

14. The method of claim 10, further comprising, after (a):
(a′) drying the primer coating.

15. The method of claim 10, further comprising, after (b):
(b′) drying the print layer.

16. The method of claim 10, further comprising, after (c):
(c′) partially curing the first radiation-curable coating material with UV radiation or an electron beam.

17. The method of claim 14, further comprising, after (b):
(b′) drying the print layer.

18. The method of claim 14, further comprising, after (c):
(c′) partially curing the first radiation-curable coating material with UV radiation or an electron beam.

19. The method of claim 15, further comprising, after (c):
(c′) partially curing the first radiation-curable coating material with UV radiation or an electron beam.

20. The method of claim 17, further comprising, after (c):
(c′) partially curing the first radiation-curable coating material with UV radiation or an electron beam.
